(19) United States
(12) Patent Application Publication
(10) Pub. No.: US 2010/0235915 A1
(43) Pub. Date: Sep. 16, 2010

(54) USING HOST SYMPTOMS, HOST ROLES, AND/OR HOST REPUTATION FOR DETECTION OF HOST INFECTION

(76) Inventors: Nasir Memon, Holmdel, NJ (US); Kulesh Shanmugasundaram, Brooklyn, NY (US)

Correspondence Address: STRAUB & POKOTYLO, 788 Shrewsbury Avenue, TINTON FALLS, NJ, 07724, US

(21) Appl. No.: 12/723,272

(22) Filed: Mar. 12, 2010

Related U.S. Application Data
(60) Provisional application No. 61/159,604, filed on Mar. 12, 2009.

(51) Int. Cl. G06F 11/00

(52) U.S. Cl. 726/23; 726/25; 709/224

(57) ABSTRACT

Detecting and mitigating threats to a computer network is important to the health of the network. Currently firewalls, intrusion detection systems, and intrusion prevention systems are used to detect and mitigate attacks. As the attackers get smarter and attack sophistication increases, it becomes difficult to detect attacks in real-time at the perimeter. Failure of perimeter defenses leaves networks with infected hosts. At least two of symptoms, roles, and reputations of hosts in (and even outside) a network are used to identify infected hosts. Virus or malware signatures are not required.

### §0. RELATED APPLICATIONS

Benefit is claimed to the filing date of U.S. Provisional Patent Application Ser. No. 61/159,604 (“the '604 provisional”), titled “METHOD AND APPARATUS FOR INFECTION DETECTION (OR RISK ASSESSMENT AND MITIGATION),” filed on Mar. 12, 2009 and listing Nasir MEMON and Kulesh SHANMUGASUNDARAM as inventors. The '604 provisional is incorporated herein by reference. However, the scope of the claimed invention is not limited by any requirements of any specific embodiments described in the '604 provisional.

### §1. BACKGROUND OF THE INVENTION

§1.1 Field of the Invention

The present invention concerns network security. In particular, the present invention concerns detecting infections of one or more host computers on a network.

§1.2 Background Information

Detecting and mitigating threats to a computer network are important to the health of the network. Currently, firewalls, intrusion detection systems (“IDSs”), and intrusion prevention systems (“IPSs”) are used to detect and mitigate attacks on the network. As attack sophistication increases, it becomes difficult to detect attacks in real-time at the perimeter of the network. Failed perimeter defenses leave networks with infected hosts.

Signature-based network security techniques look for a particular bit-string or a particular value of a known virus. However, such techniques require the signatures of viruses to be discovered and stored. Further, as the number of viruses grows, the number of signatures that must be stored and checked increases as well. Therefore, it would be useful to protect computer hosts and networks without the need to discover and store virus signatures.

Anomaly-based network security techniques focus on anomalous activities (with respect to a baseline) in the context of a host. Unfortunately, such techniques typically require the determination of a baseline of the network environment, or of the host itself, or of its history, to determine whether or not current activities are “anomalous” with respect to a norm. It would be useful to protect computer hosts and networks without the need to determine a prior “normal” history of a host or a network in general.

Similarly, behavior-based network security systems tend to define a host's normal behavior as a set of rules, and then look for any behavior that deviates from the norm. Most of such behavior-based systems currently (1) define behaviors either as aggregates on events (such as number of connections), or a number of bytes sent and/or received per some time unit, or connections made to a particular set of hosts, and (2) then monitor for deviations from such behavior. Although such systems tend to operate well in a clean environment (and with fewer false alarms than anomaly detection systems), they lack comprehensive coverage over possible and growing attack vectors. For example, since behavior-based systems tend to focus on aggregates, they are most effective at detecting denial of service (DoS) attacks or flooding attacks. However, newer attacks are more subtle and are often not conspicuous enough to register on behavior monitoring systems. For example, while behavior-based systems may look for 100 connections/second or above, an attack may only need one or two connections. Although behavior-based systems can adapt to new attacks by including new behaviors, these new behaviors are essentially signatures looking for connections to specific hosts (or IP addresses). Therefore, it would be useful to provide computer network and host security techniques that provide better protection from new attacks.

As should be appreciated from the foregoing, most anomaly-based and behavior-based infection (e.g., virus) detection systems look for events that can be changed by an attacker easily. For example, some of the protocol anomalies detected by the state-of-the-art systems include port numbers being equal, unusual protocol flags being set, fragmented packets, packets with smaller time-to-live (“TTL”) values, etc. Although these events are valuable in preventing ongoing attacks, attackers have moved on in order to avoid such scans, or have employed evasion techniques. On the other hand, sophisticated attacks now blend into and behave like normal traffic. Sometimes they even behave similar to a normal host. For example, a host committing click fraud may well look like a normal web host browsing at the level of abstraction of transmission protocols such as the Internet protocol (“IP”) and transmission control protocol (“TCP”). It would be useful to provide infection detection techniques that improve upon current techniques.

### §2. SUMMARY OF THE INVENTION

Exemplary embodiments consistent with the present invention detect infected hosts in a network by using at least two of symptoms, roles and reputation of hosts in (and outside) a computer network. Such embodiments do not require virus or malware signatures.

### §3. BRIEF DESCRIPTION OF THE DRAWINGS

FIG. 1 is a block diagram of an exemplary environment in which embodiments consistent with the present invention may operate.

FIG. 2 illustrates how the symptoms, roles, and reputation of a host can be mapped to a Cartesian space defined by symptoms, roles and reputation.

FIG. 3 is a flow diagram of an exemplary method for determining an infection risk of a host computer on a network, in a manner consistent with the present invention.

FIG. 4 is a flow diagram of an exemplary host role determination method consistent with the present invention.

FIG. 5 is a flow diagram of an exemplary method for determining and updating the reputation of a host, in a manner consistent with the present invention.

FIG. 6 is a flow diagram of an exemplary method which may be used to detect and diagnose infected hosts on a network, in a manner consistent with the present invention.

FIG. 7 is a flow diagram of an exemplary method that may be used to detect hosts with a spam bot mail-server role, in a manner consistent with the present invention.

FIG. 8 is a flow diagram of an exemplary method that may be used to detect hosts with a P2P role, in a manner consistent with the present invention.

FIG. 9 illustrates a simple decision tree that can be constructed by a network analyst to trap an infected host using information provided by systems consistent with the present invention.

FIG. 10 is a block diagram of exemplary apparatus that may be used to perform operations of various components in a manner consistent with the present invention, and/or to store information in a manner consistent with the present invention.

### §4. DETAILED DESCRIPTION

The present invention may involve novel methods, apparatus, message formats, and/or data structures to facilitate detection (and perhaps diagnosis) of an infected host on a computer network. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

§4.1 Exemplary Environment

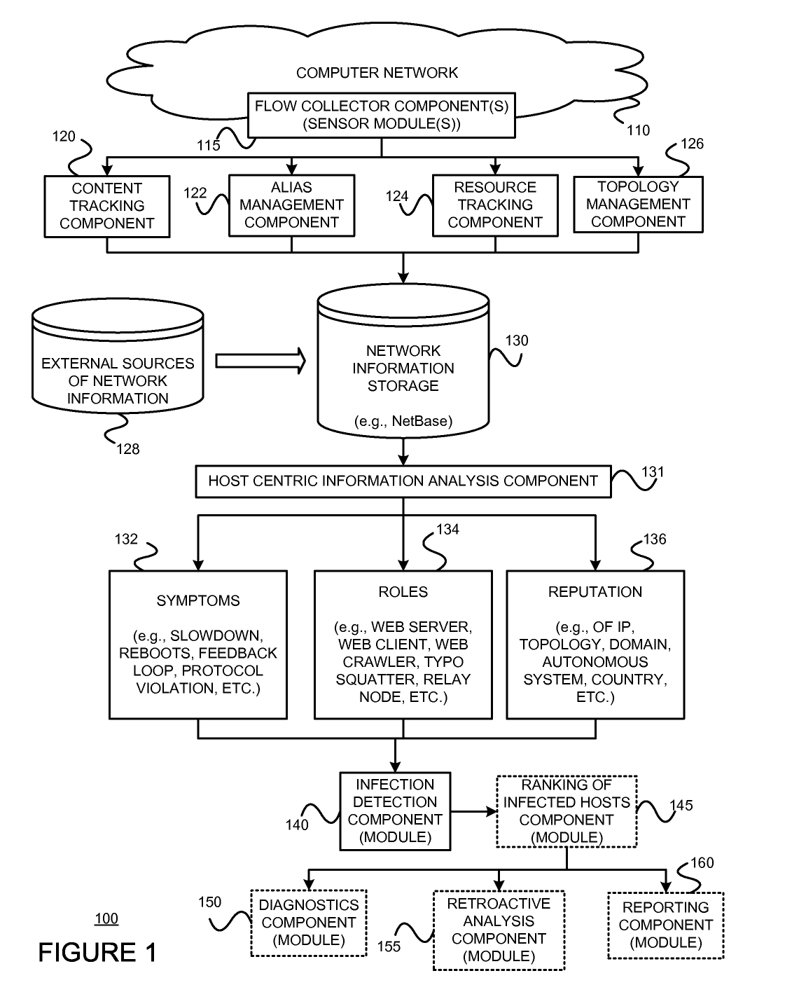

FIG. 1 is a block diagram of an exemplary environment 100 in which embodiments consistent with the present invention may operate. A variety of data from a monitored computer network 110 is gathered, for example using flow collection component(s) (e.g., “sensor modules”) 115. Such data may include, for example, raw network traffic, as well as security alerts from IDSs, IPSs and/or firewalls, various data feeds from routers, switches, and other network equipments, etc.

Collected data is processed and stored on network information storage device 130 in a compact form referred to as synopses. For example, techniques described in U.S. patent application Ser. No. 11/236,309, filed on Sep. 27, 2005, “FACILITATING STORAGE AND QUERYING OF PAYLOAD ATTRIBUTION INFORMATION,” and listing Herve BRONNIMANN, Nasir MEMON, and Kulesh SHANMUGASUNDARAM as inventors (referred to as “the '309 application” and incorporated herein by reference) may be used to generate and store synopses. Unlike products that use relational databases (“RDBMS”), such a file format and organization permits faster searching and requires less storage. Alternatively, or in addition, synopses could be stored on the sensor module(s) 115. The synopses stored on sensor module(s) 115 could be sent in streams or batches to another storage device.

External sources of network information 128 (such as blacklists, Internet routing tables, domain name mappings, etc.) may supplement the raw network traffic in NetBase 130.

Although the synopses may be directly generated by the flow collector component(s) 115 and stored on the network information storage device 130, information collected can be grouped into four major categories by a content tracking component 120, an alias management component 122, a resource tracking component 124 and a topology management component 126. Each of these components is described below.

Raw content, or summary information about content transferred over links, is considered “content.” “Content” information can be used to answer questions about the actual byte-streams or summary information about the byte-stream that traversed between hosts. Examples of content information include hosts that sent and/or received any encrypted file or a particular encrypted file, or whether any host downloaded a known malware and from where, etc.

Network protocols use various mappings or aliases between protocols and within protocols. Some examples of such mappings include DNS name to IP address (in the following, IP address is sometimes simply referred to as “IP”, as will be understood from the context by those skilled in the art), address resolution protocol (“ARP”) address to IP address, protocols to port number mappings, AS numbers to IP range, geographic boundaries to IP or domain range, etc. “Alias” or “mapping” information can be used to answer questions about the identity and probable location of a collection of hosts (and/or a single host), how the identity has changed over time, etc.

Network protocols also use various naming conventions to refer to resources in a node. For example, HTTP protocol uses Universal Resource Locator (“URL”) scheme to refer to files that form a web page. Another example would be Network File System (“NFS”), Samba, or file transfer protocol (“FTP”) using a naming format to refer to files on remote nodes over networks. “Resource indicator” information in this group can be used to answer questions about resources contained in a set of hosts, about resources/files consumed by other hosts, types of resources a set of hosts (or a single host) is interested in, etc.

Finally, information about the connectivity of nodes in a network and a variety link properties of their “connections” are considered “topology” information. “Topology” information can be used to answer questions about the connectivity of hosts to other hosts, type of connection, frequency of connection, amount of data transferred and in which directions, type of protocols used by each connection, etc.

Components 120, 122, 124 and 126, working with flow collection component(s) 115, collect data from a variety of sources, organize them into the above-described categories, and store them on disk (and in memory). There are many advantages to organizing the collected data as described above. Four of these advantages are described below.

First, since the information stored in each group are similar, they can be aggregated efficiently without loss of information. For example, information stored in the “resource indicators” category can be compressed efficiently using specialized compression algorithms. These optimizations would not be possible if the resource indicators were mixed with data from other groups.

Second, data stored within each group is not only similar in content, but is also similar in how such data might be accessed or the types of operations/transformations performed on such data. For example, data stored in the “mappings” or “aliases” category are usually subject to random access, and queries on this category are typically mapping related. Therefore, data in this category can be stored efficiently in a data structure that supports random access and mapping queries (such as a dictionary or a hash table for example).

Third, grouping the collected data into these categories allows specific application programming interfaces (“APIs”) and a set of common operators and/or functions to be designed for each category. Such an API makes it easy to design and develop analysis algorithms because storage mechanics are transparent to the algorithm developers. For example, an algorithm developer simply needs to know one function to retrieve the domain name(s) of an IP address or the media access layer (“MAC”) address(es) of an IP address (and does not need to worry about the underlying protocols or their semantics).

Finally, the grouping of collected data allows common operators and/or functions on the underlying data to be designed for each group, which can then be used on any type of data in that group. For example, a file name similarity operator can be designed for the entire “resource indicators group” which will then be used to find files with similar names or identical types (such as, all Microsoft Excel Document), regardless of whether they were transferred over HTTP, NFS, or Samba.

NetBase may organize the data collected groups and expose an API to analysis processes (examples of which are described below). In this way, analysis processes can be fully-decoupled from the mechanics of data storage.

The stored 130 synopses may be processed regularly by a host-centric information analysis component 131 to extract and/or determine host-centric information that can help detect infected hosts. Such information can be grouped into three major categories—symptoms 132, roles 134 and reputation 136. Each of these categories is introduced below.

Every infection has a purpose. For infections to survive and serve their purpose, they will have to accomplish some tasks. Examples of such tasks include spreading infections to other hosts, communicating with their controller, collecting and leaking a variety of information, etc. Inevitably, these tasks leave telltale signs in the data collected. Some of these signs are blatant, while others are surreptitious. These signs, left by an infection, are referred to as “symptoms” of the infection. Some examples of symptoms include the presence of command and control channels, a host accessing “dark space” outside the monitored network 110, a host violating protocol semantics, frequent reboots, a host slowing down, etc.

Note that unlike the state-of-the-art tools used for identifying infections which focus on individual events or their particular characteristics (better known as “signatures”) such as a byte-stream in the payload, IP or port numbers in a packet header, etc., embodiments consistent with the present invention focus on a collection of network events and their properties as a whole in the context of individual hosts in a network. The present inventors believe that the number of symptoms, unlike signatures, is a rather small, finite set which is less dependent on variations in infections. Unlike systems that use host “behavior” and “anomalies” to determine infection of a host, embodiments consistent with the present invention do not require the use of a “baseline” or a “normal” host state against which to compare host state under consideration.

A “role” is a characterization of a host in the context of other hosts in a network. Whereas a symptom can be characterized solely by the actions of a host itself, a role is characterized based on interactions of the host with other hosts. For example, a host being “alive” is a “symptom” (in that, regardless of which host it connects to, a connection coming out of a host is symptomatic of it being “alive”). In contrast, if the same connection went to a mail-server and retrieved content, then the “role” of the host is a “mail-client.” Any role, at the highest level of abstraction, can be one of a consumer, a producer, or a relay. For example, a mail-client host has a “consumer” role when it receives a mail and the mail-server host has a “producer” role. On the other hand, a mail-client host has a “producer” role when it sends a mail to a mail-sever host, which now has a “relay” role.

Finally, a “reputation” of a host may be computed as a function of (1) the nature of traffic it has received and/or sent out, and/or (2) the reputation of hosts it is associated with. For example, if a host sends out “bad” traffic it should receive a bad reputation. As another example, if a host is associated with a set of hosts with bad reputation, then it might be inferred that the host should have a bad reputation as well. Security devices, such as intrusion detection systems (“IDSs”), firewalls, black and gray lists on the Internet (such as Bleeding-edge Snort lists, Spam BL, and security mailing-lists, etc.), etc., may be used to gather information used to compute the reputation of a single host or a collection of hosts (e.g. subnet, an IP-prefix, a domain name, an autonomous system (“AS”), or a country).

Still referring to FIG. 1, an infection detection component (module) 140 may use symptoms, roles, and/or reputation of a host to detect an infection accurately. More specific examples of host infection detection using symptoms, roles and/or reputation are described in §§4.2 and 4.3 below.

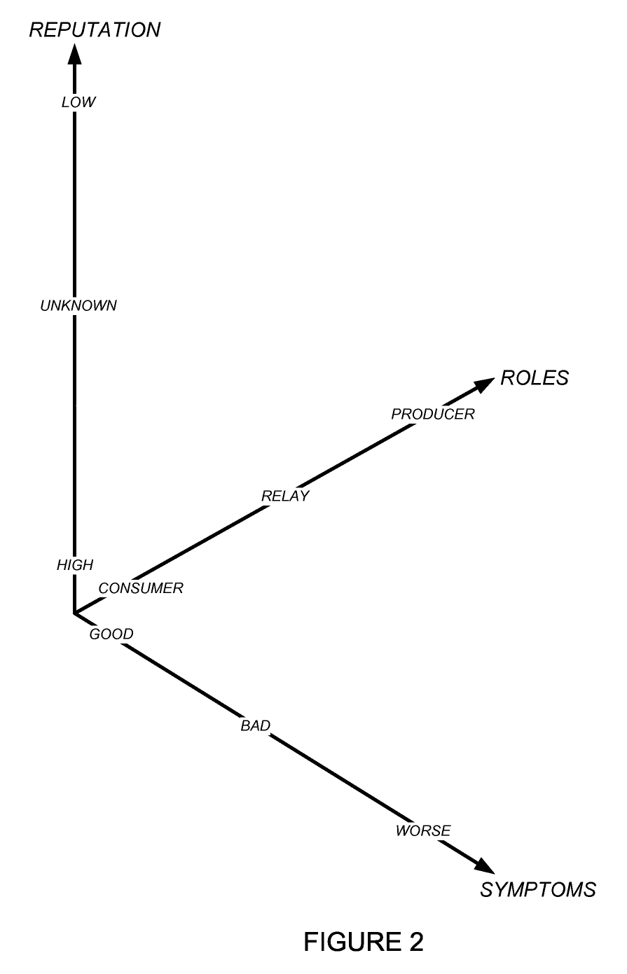

As one example, shown in FIG. 2, the symptoms, roles and reputation of a host can be mapped to a Cartesian space defined by symptoms, roles and reputation. Such a mapping may be used to cluster healthy and infected hosts into well-defined groups. For example, suppose that a host has a web-proxy role. This host then falls into the region in the middle of the role axis labeled “relay.” The host will remain in good standing as long as the reputations of its associated hosts (the web clients and web servers) have good reputations. If the host begins to contact hosts with poor reputations, it will move into a space where potential infected hosts might be. Furthermore, if the host begins to show symptoms of infection (such as having a command and control channel for example), then it will move into a space where infected hosts are. Notice that if this host is a designated as a proxy, it might be more likely to filter potentially bad traffic (using blacklists). Therefore, it would still remain with other healthy proxies. However, if a proxy is connecting to one or more IP addresses with bad reputations, then either (a) the proxy in question is malicious, or (2) the proxy is good, but not very effective in filtering the bad IPs (perhaps it's blacklist is not effective or is outdated). If the former case, then the proxy would move into infected region (Recall FIG. 2.) much more quickly and is bound to stand out as an infected proxy.

Finally, as shown in FIG. 1, infected hosts may be ranked by component 145. The ranked infected hosts may then be diagnosed by component 150, retroactively analyzed by component 155, and/or reported to one or more administrative users via reporting component 160.

Methods which may be employed by the infection detection component 140 are now described in further detail in §§4.2 and 4.3.

§4.2 Exemplary Methods for Infection Detection

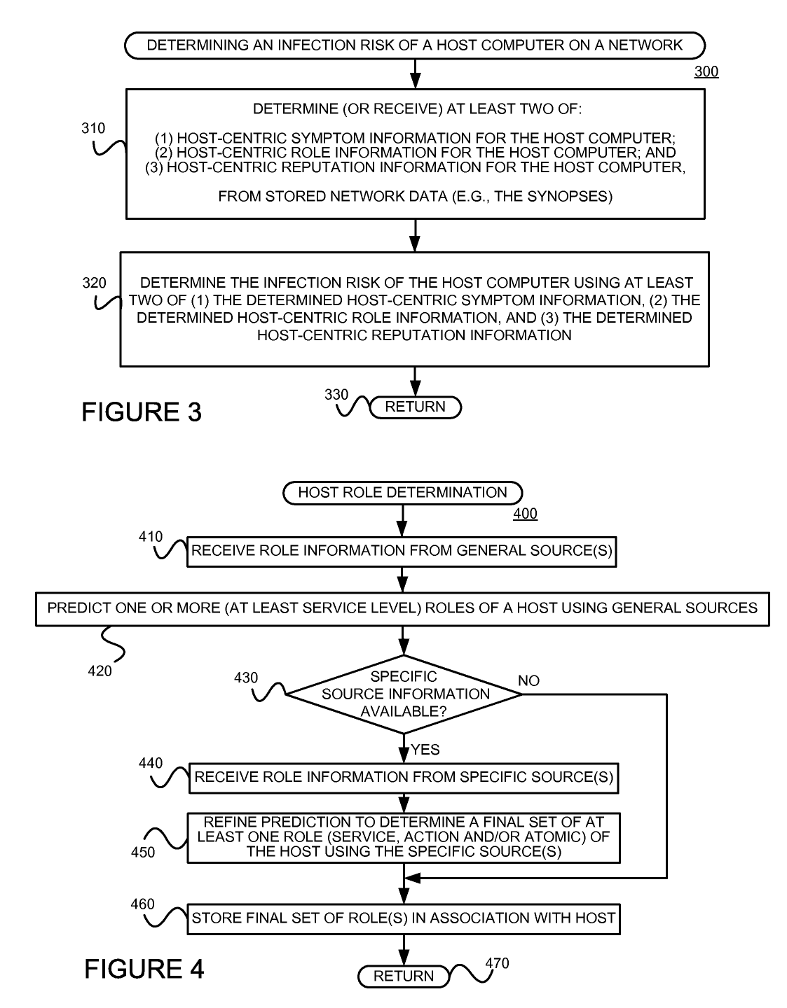

FIG. 3 is a flow diagram of an exemplary method 300 for determining an infection risk of a host computer on a network in a manner consistent with the present invention. First, at least two of (1) host-centric symptom information for the host computer, (2) host-centric role information for the host computer, and (3) host-centric reputation information for the host computer, are determined from the stored network data (e.g., synopses of data collected from the network and/or information from external sources). (Block 310) Then, an infection risk of the host computer is determined using at least two of (1) the determined host-centric symptom information, (2) the determined host-centric role information, and (3) the determined host-centric reputation information (Block 320) before the method 300 is left (Node 330).

In at least some embodiments consistent with the present invention, the determined host-centric symptom information is signature-free information. In at least some embodiments consistent with the present invention, the determined host-centric symptom information does not include baseline information of the host.

In at least some embodiments consistent with the present invention, the determined host-centric role information includes one of (A) a consumer with respect to at least one other system on the network, (B) a producer with respect to at least one other system on the network, and (C) a relay with respect to at least two other systems on the network.

In at least some embodiments consistent with the present invention, the determined host-centric reputation information is determined using (1) a reputation of at least one other system on the network with which the host has sent or received information (or that the host is otherwise associated with), and/or (2) a characterization of traffic the host has received or sent.

§4.3 Refinements, Alternatives and Extensions

§4.3.1 Examples of Symptoms

Before describing “symptoms”, an “infection” is first defined. In the context of the present invention, the definition of infection goes beyond computer viruses and worms. Rather, any disruptive behavior, entity, or technology in a network may be considered as an infection (e.g., whether it is a zombie that can spread automatically, or Google Desktop which spreads via word of mouth, or advertising, or a new torrent client). Although some of these are commonly not considered to be a threat to network security, such “infections” can be more damaging to a business, enterprise, or a person than a virus or a worm because some of these “infections” tend to affect more valuable targets than worms or viruses. For example, a peer-to-peer client may leak valuable trade secret, intellectual property, or personal data because they tend to have immediate access to such valuable data on a host. Some examples of the common infections discussed below include Botnets/Zombies, Peer-to-Peer (“P2P”) nodes, Adware, Google Desktop, Skype, Sony/Suncomm CD like “phone-home” software, etc. (e.g., a user who discovers the latest “cool thing”).

Each of these “infections” has a purpose—some benevolent, others malicious. For infections to survive and serve their purpose, they will have to accomplish certain tasks. Examples of such tasks of “infections” include spread to other hosts, keep in touch with their controller and receive commands, collect and leak information, serve up pop-up advertising, be a traffic relay for other infected hosts, etc. The process of accomplishing any of these tasks leaves telltale signs in the form of various network events. The culmination of these signs is referred to as a “symptom.”

Some examples of symptoms which may be monitored and considered by embodiments consistent with the present invention include (i) protocol semantic violations, (ii) access to dark space, (iii) slowdown of a host, (iv) change of role, (v) frequent and/or untimely reboots, (vi) contact with typo squatter domains, (vii) command and control channels/feedback loops, (viii) heavy rate of advertisement consumptions, etc.

Symptoms, in general, can be categorized into the following groups—protocol misuse, protocol semantics violations, host-based symptoms and link-based symptoms. Each of these groups of symptoms is described below.

Current state-of-the-art tools use protocol misuse or protocol anomalies to weed out potential attackers or reconnaissance hosts. Examples of protocol misuse include source and destination IP address numbers being equal, packets being fragmented, time-to-live (“TTL”) field being unusually low or high, private IP addresses on public network, etc.

Unlike protocol misuse or anomalies, protocol semantics violations can be determined by observing multiple protocols and their interrelationships. An example of a protocol semantics violation is that almost all legitimate services use domain names. Therefore, a proper semantic for a host to establish a connection would be to request its domain name server (“DNS”) to resolve a DNS name to an IP address before establishing a transport layer link. When a host establishes a connection to an IP address (that might or might not have a domain name) without requesting a resolution from a DNS server, then the question is where did the host get the resolution (meaning the corresponding IP address) from? This situation violates the semantics of DNS-IP protocols on a network. Likewise, when a host sends out an HTTP request, it appends a “Host:” field in the form of “Host: example.com.” For a host to append this field with a host name, it should have looked up the DNS name of the host name before sending the request. Otherwise, the host is in violation of HTTP-DNS semantics.

The type of traffic that is carried over connections of a service, such as email or the web, can be identified, and then checked for protocol violations. Usually, for example, these services carry plain-text, JPEG, and some compressed/encoded/encrypted traffic. A semantic violation on the protocol's part might cause the connection to carry the wrong content. For example, an unsecured HTTP connection should not carry encrypted payload because only a secured HTTP connection is supposed to carry encrypted content, not an unsecured one.

Host-based symptoms can be determined by monitoring traffic sourced or transmitted from (or sunk or received by) a host, regardless of the source or destination of such traffic. Examples of symptoms that fit into this category are slowdown (performance degradation) of a host (Techniques for detecting host slowdown such as those used in U.S. Patent Application Ser. No. 60/986,927, titled “NON-HOST BASED INFECTION DETECTION VIA SYSTEM SLOWDOWN,” filed on Nov. 9, 2007, and listing Nasir MEMON, Husrev Taha SENCAR, and Kulesh SHANMUGASUNDARAM as inventors; and U.S. patent application Ser. No. 12/037,212, titled “NETWORK-BASED INFECTION DETECTION USING HOST SLOWDOWN,” filed on Feb. 26, 2008 and listing Nasir MEMON, Husrev Taha SENCAR and Kulesh SHANMUGASUNDARAM as inventors (both incorporated herein by reference) may be used.), change in reputation, etc.

Link-based symptoms can be determined by examining the links a host has established temporally, and/or topologically. For example, host reboots tend to cause the host to connect to a set of services at predetermined destinations within a certain time window. Therefore, by analyzing the connections made by a host within a certain time period, one can infer whether it has rebooted or not, and when. (Techniques for detecting host reboot, such as those used in U.S. Patent Application Ser. No. 60/986,920, titled “A METHOD FOR PASSIVE DETECTION OF REBOOTING HOSTS IN A NETWORK,” filed on Nov. 9, 2007 and listing Kulesh SHANMUGASUNDARAM and Nasir MEMON as inventors; and U.S. patent application Ser. No. 12/268,190, titled “PASSIVE DETECTION OF REBOOTING HOSTS IN A NETWORK,” filed on Nov. 10, 2008, and listing Kulesh SHANMUGASUNDARAM and Nasir MEMON as inventors (both incorporated herein by reference) may be used.) Further, the content on the link can be analyzed to identify connections that carry similar and/or identical content. So a host being part of several connections (substantially) identical to other hosts that are infected (or showing signs of infection) is an example of another link-based symptom. Furthermore, link-based symptoms can also include a host being associated with one or more known infected hosts (or as described below, having been associated with too many hosts with bad reputations). Moreover, a host attempting to access hosts that are not actually present in a network (accessing the “darkspace”) is another example of a link-based symptom.

The foregoing examples of protocol misuse symptoms, protocol semantics symptoms, host-based symptoms and link-based symptoms are summarized in Table 1, here.

TABLE 1
Examples of various symptoms and their groups.

| Protocol | Protocol | | |
|---|---|---|---|
| Misuse | Semantics | Host-based | Link-based |
| Identical port | Links without DNS | Change of role | Access to darkspace |
| numbers | query | | |
| Small TTL | Host: without DNS | Slowdown | Control channels |
| | query | | |
| Fragmented | IP without ARP | Change in | Frequent reboots |
| packets | lookup | reputation | |

§4.3.2 Examples of Roles

As discussed in §4.1 above, a “role” of a host is characterized in the context of other hosts it has contacted. A role of a host can be determined using one or more of security logs, flow records, log data, etc. Two types of procedures—heuristics and learning algorithms—can be used for host role determination. More specifically, heuristics, provided with appropriate data, may be used to determine the role of a host. On the other hand, learning algorithms can be used to learn the role of a host defined by a set of features or characteristics, and then use the resulting model to determine the role of new hosts. Although both methods have false positives and false negatives, if the process of determining a role(s) of a host is repeated on new data, the roles for a particular host will converge over time.

Data sources used by the detection algorithms can be categorized as a general source or a specific source. Each category is described below.

General data sources produce logs for mundane network activities and do not provide any special tags for data items, at least from a security perspective. For instance, Netflow records produced by routers and switches simply provide tuples of information (e.g., source IP address, destination IP address, port numbers, protocol, TTL (time to live), number of packets, amount of data transferred, etc.) about packets forwarded by the device. The tuples generally do not have any markers that directly indicate the role of a host.

Current networks have many special purpose appliances monitoring network traffic for applications in security, billing, and traffic engineering. Logs produced by these devices generally carry valuable information that can be used to determine the role of a host accurately. For example, using an alert for a worm from an IDS, the role “infected host” to the host that triggered the alert. Furthermore, individual hosts also produce application specific logs. These logs also carry useful information that can help determine the role of a host. For example, analyzing an access log from a web server, a host can be identified as having a role of “web crawler” if it accesses “robots.txt” prior to other pages. The foregoing are examples of special data sources.

Role detection can also attribute roles to a particular host at various levels of abstractions. At the highest level of abstraction, a host can be consumer, producer, or a relay. In general, roles may be categorized into three groups—service roles, action roles and atomic roles. Each type of role is described below.

Service level roles are non-intrusive roles generally determined by analyzing the data from general sources, and/or special sources in a superficial manner. Examples of service level roles include, for example, web server, web client, crawler, workstation, mail-client, mail-server, DNS server, P2P node, port-scanner, brute-forcer, router, NAT, etc.

Action roles further define the type of action taken for each service role. This level of labeling is more intrusive than service level role labels. For example, once it is determined that the role of a host is a “web client,” the host can be further analyzed to determine whether the web client host (A) sends more data to the web server, or (B) receives more data from the web server. If the “web client” host sends more data than it receives, it may be further labeled as “web client producer,” and otherwise labeled as “web client consumer.” As another example of action role labeling, suppose there is a host whose service level role is “workstation.” If an IDS alert indicates that this host is sending a worm, this host may be assigned a “workstation infected” action level role.

Finally, atomic roles may be assigned to each host at the lowest level of abstraction with respect to another host or a set of other hosts. For example, a host (10.0.2.1) that initiates a connection to another host (10.0.2.2) and downloads data might be provided with the atomic label “10.0.2.1 is a consumer of 10.0.2.2.” As another example, a host (10.0.2.1) that connects two other hosts (10.0.2.2 and 10.0.2.3) might be provided with the atomic label “relay of 10.0.2.2 and 10.0.2.3.”

The levels of roles (service, action or atomic) that can be assigned to each host depend on the depth of information available about the host (e.g., in NetBase). In general, role determination methods use all appropriate sources to attribute the right role(s) at the right level of abstraction to each host.

FIG. 4 is a flow diagram of an exemplary host role determination method 400 consistent with the present invention. As shown, the method 400 receives role information about the host from a general source(s) (Block 410) and predicts one or more (at least service level) roles of the host using the received general source information (Block 420). If specific source information is available (Block 430), such information is received from specific source(s) (Block 440), the prediction is refined to determine a final set of role(s) (e.g., service, action, and/or atomic) of the host using the information received from the specific source(s) (Block 450), and the final set of roles is stored in association with the host (Block 460) before the method 400 is left (Node 470). Referring back to block 430, if there is no specific source information available, the method 400 simply branches to block 460, already described above. (The predicted role(s) is the final role(s) of the host under such a scenario.)

Thus, in general, a role determination method consistent with the present invention may attempt to use data from general sources to predict the role(s) of a host as a first step. This arrangement is made based on the observation that general sources often contain information that is superset to that of special sources. Therefore, even when firewalls and IDS do not have any log entry for a host, a role, however inaccurate, can still be assigned to the host. This ensures that each host that is observed in a network, both inside and outside, can be assigned at least one role. Service level roles can almost always be predicted using general sources. (Recall, e.g., blocks 410 and 420 of FIG. 4.)

Action and atomic roles, however, require more specific information contained only in special sources. For example, to assign an “infected by GTBot” action role, data from an IDS log may be needed.

In any case, the first step in the exemplary role determination method is role prediction. The prediction may not always be accurate. In the next step, the exemplary role determination looks for any specific information that can be used to increase the accuracy of the prediction in the first step and/or to determine a more specific role. This includes consulting special sources to verify the decisions made in the first step. For example, after the first step, the role determination method may come up with a label “web client” for a host. After consulting web server logs or comparing the number of unique hosts connected across with other “web clients” in the network, in the subsequent role refining step, it can then be determined that the “web client” host is in fact a “web crawler” host. (Recall, e.g., 430, 440, and 450 of FIG. 4.) Finally, the roles that a particular host is associated with are determined and passed on to the NetBase for storage. (Recall, e.g., 460 of FIG. 4.)

§4.3.3 Examples of Reputation

Reputation of a host may be computed as a function of (i) the nature of traffic it has received and/or transmitted, and/or (ii) the reputation of hosts it has been associated with. For example, a host's reputation can be a number between 1 and −1 where −1 indicates a bad reputation, 1 indicates a good reputation, and 0 indicates an unknown reputation. Given a set of n hosts associated with (e.g., that exchange data with, or peer with, or that are otherwise related to (e.g., as described in §4.3.3.1 below)) a host H, reputation of the host H for a time period T (R_{H}^{T}), can be computed by:

$${R}_{H}^{T} = \frac{{\sum }_{i = 1}^{n} {R}_{i}^{T} + α \cdot {R}_{i}^{T - 1}}{n} \qquad ( 1 )$$

where α is a decay factor and T-1 is the previous time period.

The nature of traffic that has been transmitted by or received from a host, at least labeled as “good” or “bad”, may be obtained from many different sources. For example, IDS and firewalls produce alerts indicating hosts that produce or receive bad traffic. Publicly available blacklists are another source of such information, as are security mailing lists where network administrators discuss certain IP addresses that are attacking their networks. A combination (e.g., an average, a weighted average based on the source, based on heuristics, etc.) of information from all such sources can be used to assign the reputation for hosts in the sources.

A source of such bad IP addresses is generally referred to as a blacklist. In some embodiments consistent with the present invention, all hosts in a black list will be assigned a bad (e.g., −1) reputation. Note that there are various security tools, such as IDS, firewalls, etc. that use blacklists directly to block “bad traffic.” Unfortunately, information gathered from blacklists is sometimes of limited use, because attackers can change IP addresses or move from one location to another. Further, pruning a black list remains more of an art than a science. Thus far, there is no well-accepted method on how to prune a blacklist.

However, information contained in blacklist can be used to bootstrap a reputation system that can not only gauge the reputation of the IPs present in the list, but also IPs that are not in the list. Furthermore, this provides a model on which to base methods for pruning a blacklist. Moreover, to bootstrap reputations of IPs not in a blacklist, relationships between hosts that are on the blacklist and hosts that are not may be used to infer reputations of hosts. Such inferences make sense because even a host with a good reputation may get infected if it was in contact with a bad host for a long enough time. For example, if a host with a good reputation is contacting and downloading information from a host with a bad reputation, it is reasonable to assume that at some point the good host is bound download something bad.

§4.3.3.1 Inferring Host Relationships Used to Infer Reputation

In this section, different ways to infer relationships between hosts on the Internet are described. One simple way to infer relationships between hosts is by monitoring the relevant network traffic and establishing a relationship based on who is connecting to whom. However, this method relies on observable traffic between hosts and does not work well when it is desired to establish relationships between hosts on the Internet whose traffic cannot be observed. As described below, relationships between hosts can be inferred from one or more of (i) direct connections, (ii) connections via proxy, (iii) aliases, (iv) infrastructure relationships and (v) topology relationships.

The simplest form of inference is observing that two or more hosts established a relationship by directly contacting each other. For example, using data in NetBase, hosts that connected to each other can be identified, thereby inferring a relationship between such hosts.

Sometimes, a host connects with another host indirectly, through a proxy. A good example of this is when hosts in an enterprise network connect to hosts on the Internet via a web proxy. Simply examining IP addresses would not reveal the fact that a web client has in fact connected to dozens of hosts since such connections were made via the proxy. However, examining application level information (such as HTTP headers for example) can reveal the real source of information. Therefore, it might be desirable for reputation of a host to consider the reputation of the real source of information received by the host, and not just the proxy.

An important infrastructure on the Internet is the domain name service (“DNS”). DNS translates human readable domain names to IP addresses. Likewise, there are many other aliases that make up the inner workings of Internet. Another such example is the virtual host header in HTTP protocol which maps an IP address to a domain name. Using such aliases, relationships between IP addresses that may or may not share or belong to the same commercial entity may be determined. For example, two different companies may host their web site on the same host (IP address) at a hosting service provider. HTTP uses virtual host (or Host: header field) to map the domain names to the corresponding IP address. If one web site is infected or marked as a bad web site, it is highly likely that the other one is also infected since they are hosted in the same host. Therefore, using virtual host aliases, a relationship that two different websites are hosted on the same machine can be inferred.

Often IP addresses are assigned to countries, Internet service providers (“ISPs”), and enterprises in large blocks known as autonomous systems (“ASs”). Therefore, given an IP address, it can be mapped to the owner, country, or AS. Consequently, a relationship between hosts with IPs in the same assigned block can be inferred.

Finally, another way to infer a relationship between IP addresses (or domain names, or ASs) is to consider the network topology and establish a “distance” between IP addresses. For example, given the two IP addresses 128.238.35.91 and 128.238.35.90, it can be inferred with high probability that the hosts associated with these IP addresses are close to each other. Thus, a bit-wise distance between host IP addresses can be used to infer relationships between them. That is, if the bit-wise distance between host IP addresses is less than a determined (e.g., predetermined) value, a relationship between the hosts can be inferred.

§4.3.3.2 Bootstrapping and Updating a Reputation System

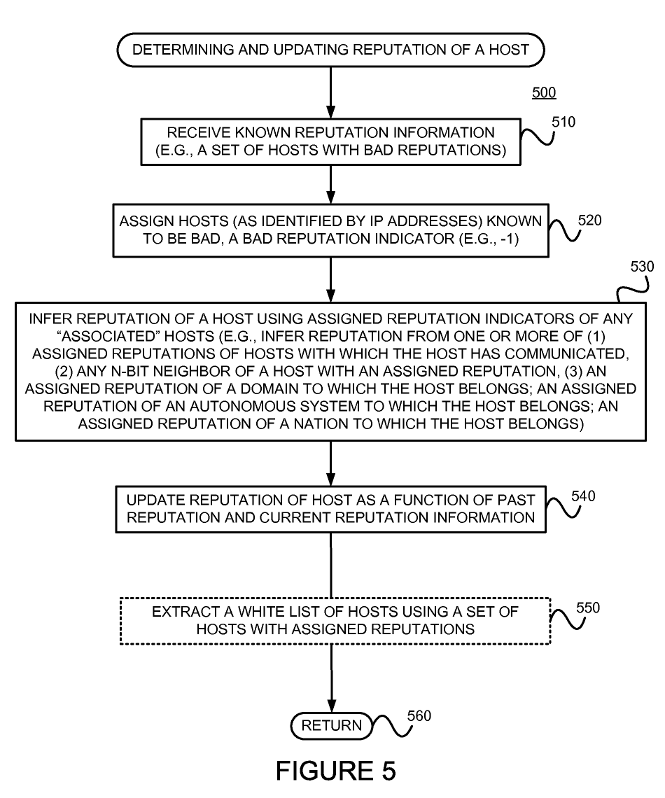

In some embodiments consistent with the present invention, it may be desirable to “bootstrap” reputation values of hosts. FIG. 5 is a flow diagram of an exemplary method 500 for determining and updating the reputation of a host in a manner consistent with the present invention. First, known reputation information (e.g., a blacklisted set of hosts) is received. (Block 510) Hosts (or the IP address of such hosts) known to be bad are assigned a bad reputation indicator (e.g., −1). Then, a reputation of a host without a known or assigned reputation is assigned to that host using assigned reputation indicators of associated (e.g., hosts that had established connections with the host, hosts with an IP address within n-bits of the host, hosts in the same domain as the host, hosts within the same autonomous system as the host, hosts within the same nation as the host, etc.). (Block 530) This effectively assigns reputation indicators (e.g., values between −1 and 1, or between 0 and −1) to hosts that did not previously have an assigned reputation. (Note that in some embodiments consistent with the present invention, the initially assigned reputation values may become less than −1 or greater than 1.)

The method 500 may then update the reputation of the host as a function of both (1) its past reputation(s) (weighed by a decay function) and (2) its current reputation. (Block 540)

The method 500 may also extract a white list of hosts using a set of hosts with assigned reputations. (Block 550) The method 500 may then be left. (Node 560)

As should be appreciated from the foregoing, a reputation system may be bootstrapped with known reputations of hosts, reputations of domains, reputations of ASs, and/or reputations of countries. Once the reputation system is bootstrapped in this way, it can then evolve (e.g., updated periodically) based on newly available information.

Bootstrapping a three-state (good, unknown, bad) reputation system would need to use a set of hosts assigned with bad reputation and a set of hosts assigned with good reputation as input. All other hosts would be considered to have unknown reputation. (Note that a two-state reputation system (unknown and bad) would only need to use a set of hosts assigned with bad reputations, since all other hosts would be considered to have an unknown reputation.)

There are many sources of information about hosts with a bad reputation. Such sources include, for example, (i) blacklists of infected hosts and spammers (such as Bleeding-Edge Snort, Dsheild, etc.), (ii) security devices in a network (such as IDSs, IPSs, firewalls, antiviral software etc.), (iii) security mailing lists, especially incidents and incident response lists, (iv) web searches in which an IP is searched on the web and the search results are evaluated, etc.

Finding a set of hosts with good reputation on the other hand is much more difficult. One way to generate such a set would be to white list well-known domains and autonomous systems (such as Google, Yahoo!, Microsoft, etc.) as having good reputation. This approach, however, is subjective. Embodiments consistent with the present invention may employ a more robust approach, described later in this section.

Referring back to block 510 of FIG. 5, in some exemplary methods consistent with the present invention, the reputation system is bootstrapped only with known bad hosts. For example, suppose a reputation system under consideration is to have reputation defined at the following five levels: specific IP addresses of hosts, bitwise neighbors of IP, domains, autonomous systems, and nations. Referring to blocks 520 and 530 of FIG. 5, bootstrapping such a system might be performed as follows.

First, a bad reputation (e.g., −1) is assigned to all IP addresses in black lists. If an IP address appears on multiple black lists from different sources, its assigned reputation might be worse. The rest of the IP addresses in the IP space under consideration (that is, the rest of the hosts under consideration) are assigned an unknown reputation (e.g., 0).

Second, the reputation of a host may be inferred from bit-wise “neighbors” (i.e., hosts within a predetermined bit-wise distance from the host, or all hosts, weighted by bit-wise distance). For example, suppose Iₙ indicates an n-bit neighbor of a host at IP address I, and R(I) is the reputation of a host at IP address I from the reputation system as bootstrapped above. Then, the reputation of any n-bit neighbor of IP address I, R(Iₙ), can be computed in the following manner:

$$R ( {I}_{n} ) = \frac{{\sum }_{i = 0}^{2 n} R ( {I}_{i} )}{{\sum }_{i = 0}^{2 n} V ( {I}_{i} )} \qquad ( 2 )$$

where V (I) returns 1 if the IP address I is seen in network traffic during a preset period of time, and 0 otherwise. In essence equation (2) splits the reputation of known bad hosts with their bitwise neighbors known to have been active in the network, where the reputation is computed. Note the special case when none of the neighbors of an IP address in question is seen in the network, that is if ΣV(Iᵢ)=0, then the n-bit neighbor's reputation is ΣR(Iᵢ).

Third, similar to blacklists for IP addresses, there are also blacklists for domain names. Therefore, for domains known to have a bad reputation, for each occurrence of a domain in a blacklist, it may be assigned a bad reputation (e.g. −1), or its reputation may be adjusted downward. Therefore, in embodiments that do not use a white list, after bootstrapping, a domain name may have a bad reputation ((−1) and below) or have an unknown reputation (0). Alternatively, a domain with an unknown reputation may be assigned a cumulative reputation indicative of the assigned reputations of IP addresses represented by the domain. For example, suppose domain “example.com” resolves to IP addresses Iₙ. Then the reputation of the domain might be computed as follows:

$${R}_{example . com} = {\sum }_{i = 0}^{2 n} R ( {I}_{i} ) \qquad ( 3 )$$

In some embodiments consistent with the present invention, a name server's reputation may be included into the domain itself.

Worst name servers play authoritative to worst domains. More specifically, each domain name (example.com, for instance) has an authoritative name server (a DNS server) on the web. When a host wants to resolve example.com, it will send a request to its local DNS server asking for the IP address of example.com. If the local DNS server doesn't know the answer, it will escalate this request to an “authoritative resolver” that is responsible for always knowing which IP example.com resolves to. An authoritative resolver may be “authoritative” to many domain names. Thus, if a domain has a bad reputation, then the corresponding authoritative server may also be assigned a lower reputation for being the authoritative server for that bad domain (by association). Furthermore, other domains that this bad authoritative server is responsible for can also be assigned a lower reputation.

Fourth, the reputation of an autonomous system may be inferred. Usually, autonomous systems, as a whole, are not blacklisted. Therefore, bootstrapping an autonomous system's reputation might be done by inferring reputation of the AS from the reputations of specific IP addresses belonging to the AS, and/or domain names belonging to the AS. For example, the reputation of an autonomous system with a single and contiguous IP address block can be computed by using equation (2) where ΣV(Iᵢ) is a cumulative reputation of hosts at IP addresses that are known to have a bad reputation and that map to the AS, and where ΣV(Iᵢ) is the number of IP addresses that belong to the AS which are active in the network.

Finally, similar to inferring an autonomous system reputation, a national (or country) reputation can also be computed using the IP address space assigned to each nation.

Although the foregoing described how a reputation system might be bootstrapped based solely on blacklists of IP addresses, the hierarchy established above can also be bootstrapped from the bottom-up. For example, suppose a blacklist of domains were available. In such a situation, the reputation system can still be bootstrapped by assigning to the reputation of hosts at IP addresses within the domain, the reputation of the domain itself.

As should be appreciated from the foregoing, reputation can be inferred from individual hosts with assigned reputations (e.g., hosts on a blacklist) to some group of the hosts (e.g., domains, ASs, countries). Conversely, once a group of hosts has an assigned reputation, that assigned group reputation may be applied to other hosts (e.g., hosts without assigned reputations) belonging to the group.

Referring back to block 540 of FIG. 5, assigned reputation values may be updated (e.g., periodically, and/or as more information becomes available). That is, as time goes by, reputations in the system should be adjusted to better reflect more current information about reputation. For example, new IP addresses and/or domain names might be assigned bad reputations as they appear in blacklists, while old IP addresses and/or domain names with bad reputations might be updated to reflect a better reputation. One way to maintain such a system is to let any entity assigned an explicit reputation, such as an IP address or domain name, adjust (e.g., slowly improve) their reputation using a decay function. An example of a simple decay function is an exponential decay function. Therefore, in a given update cycle, any entity assigned an explicit reputation might use a decay function to adjust (e.g., improve) its reputation as long as the entity is not assigned a reputation during the cycle. Such periodic updates to reputations permit bad hosts to improve their reputations (e.g., to a unknown reputation) if they are cured for a sufficient number of update cycles. Similarly, the reputation of a host may be a time-weighted combination of a current reputation and one or more past reputations (in which older reputations are weighted less.)

Referring back to block 550 of FIG. 5, in some embodiments consistent with the present invention, a whitelist may be extracted. More specifically, some of the foregoing examples described how to use a blacklist to bootstrap a reputation system with two states—a bad reputation and an unknown reputation—and to update the system periodically to reflect changes in the reputations of hosts and/or domains. In some embodiments consistent with the present invention, a two-state reputation system may be used to bootstrap a three-state reputation system by automatically generating a whitelist from the two-state system. More specifically, in such exemplary embodiments, in addition to the two states (bad and unknown) in a two-state system, a third state (good reputation) is added to the reputation system. Suppose, for example, that a two-state reputation system has evolved over a period of time. Recall one of the applications of a reputation system is to monitor the reputation of internal hosts over time to identify trends, or to detect changes. IP addresses or domain names that have a good reputation might be determined as follows.

Over a period of time (e.g., a week), compute the reputation of monitored hosts based on the reputation of related hosts. Reputation of a monitored host might be a cumulative reputation of host IP addresses linked to (or more generally, related to) the host. At the end of each computation, extract hosts with unknown reputations (e.g., 0) in a two-state reputation system. All associated hosts with these hosts are included in the daily whitelist. Once a satisfactory number of such daily whitelists are determined, a final whitelist might be determined using the intersection of all the daily whitelists. The final whitelist might be used to bootstrap a three-state reputation system. Updating a three-state reputation system is almost identical to updating a two-state system, with the additional step of introducing new hosts with good reputations into the system, and decaying the reputation of existing hosts with good reputations that have not been assigned in the current update cycle.

§4.3.4 Diagnosis

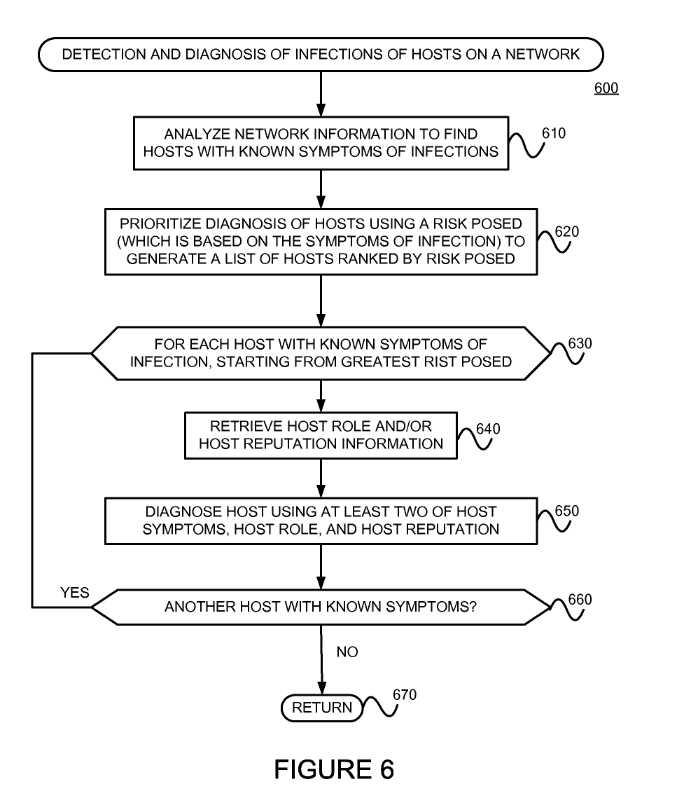

FIG. 6 is a flow diagram of an exemplary method 600 which may be used to detect and diagnose infected hosts on a network. Network information is analyzed to find hosts with known symptoms of infections. (Block 610) Recall, however, that symptoms may be benign. Diagnosis of hosts is prioritized using a risk posed (which is based on the symptoms of the infection) to generate a list of hosts ranked by the risk posed. (Block 620) For each of the hosts with known symptoms (e.g., starting with the host with the greatest risk posed and proceeding until reaching the host with the least risk), a number of acts are performed (Loop 630-660) before the method is left (Node 670). More specifically, for each host, host role and/or reputation information is retrieved (Block 640) and the host is diagnosed using at least two of host symptoms, host role(s) and host reputation (Block 650).

Diagnosis attempts to answer the following questions automatically. What is the nature of infection? Where did the infection come from? Which other hosts are infected by similar infections? How much risk is this infected host posing to the network/organization? What is the rank of this host (in relation to all other hosts)?

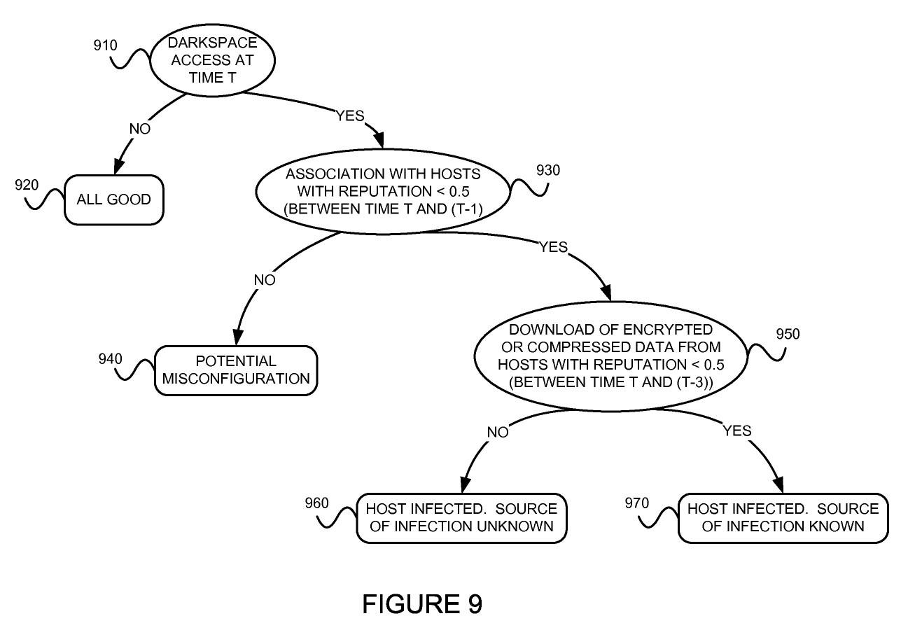

After diagnosis is completed, embodiments consistent with the present invention may generate a summary report with the findings. Just as the organization of collected data in NetBase helps make designing new analysis algorithms easy, the organization of host behaviors into symptoms, roles, and reputation makes the development and automation of new diagnostics (beyond those described here) easy. For example, a network administrator can quickly put together an “and-graph” or a decision tree of symptoms, role(s) and/or reputations (See FIG. 9.) to describe an infection in a network. This information can then be analyzed during diagnostics and a summary report can be produced automatically.

Note that to put this diagnostics together, a network administrator doesn't need to worry about where the data is stored or how to detect “darkspace” in his or her network. Abstracting the storage system and abstracting various host behaviors into symptoms, roles and reputation helps a network administrator focus on describing an infection in plain and simple words. (See, e.g., decisions 910, 930 and 950 of FIG. 9.) Furthermore, with diagnostics results clearly identified (See, e.g., elements 920, 940, 960 and 970 in FIG. 9.) the system can automatically identify infections at early stages. For example, with the sources of downloads identified for a single host the system can immediately start looking for other hosts that have made contact with the same hosts or have downloaded similar content. These hosts are potential candidates of infections as well and can be listed along with the results of this diagnostics.

§4.3.5 Containment and Corrective Actions

Although not shown on FIG. 1, hosts having a detected infection may be contained, (to prevent the spread of a virus or malware and/or to prevent or reduce damage inflicted by the virus or malware). Depending on a diagnosis, various corrective actions (including those known in the art) may be taken, either automatically, or responsive to a manually entered command by an administrative user.

§4.4 Exemplary Applications of Infection Detection Consistent with the Present Invention

§4.4.1 Using Symptoms for Detection

§4.4.1.1 Detecting a Remotely Controlled Bot

A remotely controlled bot, by definition, should have a command and control channel. In addition the bot is in the network to serve a purpose for the attacker. Therefore, for example, the symptoms exhibited by a remotely controlled bot could be one or more of the following: (i) presence of a command and control channel; (ii) a change in role (such as, for example, becomes a relay: relaying traffic of other hosts, becomes a spammer: host sending out too many emails, becomes a scanner: host scanning a network's unused IP range or attempting to access IPs that don't exist, becomes a brute forcer: host attempting to brute force services, becoming a peer-to-peer node, etc.); and (iii) contact with fast-flux domain. Once a host is attributed with one or more of these symptoms, the host may be considered to be compromised and used as a bot.

§4.4.1.2 Detecting a Malware Infected (Unstable) Host

A host can be infected by one or more malware that can cause the host to become unstable, and/or slow. In such cases a host might exhibit the following symptoms: (i) the host slows down in reacting to network events; and (ii) the host may become unstable and reboot frequently. Techniques described in U.S. Patent Application Ser. No. 60/986,920, titled “A METHOD FOR PASSIVE DETECTION OF REBOOTING HOSTS IN A NETWORK,” filed on Nov. 9, 2007 and listing Kulesh SHANMUGASUNDARAM and Nasir MEMON as inventors; U.S. patent application Ser. No. 12/268,190, titled “PASSIVE DETECTION OF REBOOTING HOSTS IN A NETWORK,” filed on Nov. 10, 2008, and listing Kulesh SHANMUGASUNDARAM and Nasir MEMON as inventors; U.S. Patent Application Ser. No. 60/986,927, titled “NON-HOST BASED INFECTION DETECTION VIA SYSTEM SLOWDOWN,” filed on Nov. 9, 2007, and listing Nasir MEMON, Husrev Taha SENCAR, and Kulesh SHANMUGASUNDARAM as inventors; and U.S. patent application Ser. No. 12/037,212, titled “NETWORK-BASED INFECTION DETECTION USING HOST SLOWDOWN,” filed on Feb. 26, 2008 and listing Nasir Memon, Husrev Taha Sencar and Kulesh Shanmugasundaram as inventors, may be used to detect (and address) such symptoms. Once a host is attributed these symptoms, culprits who may have infected the host may be determined in a diagnosis phase.

§4.4.2 Examples of Using Roles for Detection

§4.4.2.1 Detecting a Spam Bot

Currently, attackers use compromised hosts to send spam or phishing emails to unsuspecting users. A compromised host being used to send spam can be detected when its role changes from “mail-client” to “mail-server,” and/or when it takes on a “mail-server” role out of the blue. Unfortunately, detecting a host having a “mail-server” role is not straight forward since SMTP is a symmetric protocol. (SMTP is a symmetric protocol in that both a mail client sending a mail to its mail-server and a mail-server send mail to another mail server establish connections to the same port and speak the same language.) To distinguish a “mail-server” from a “mail-client,” embodiments consistent with the present invention assume that the fan out of a mail-server is much higher than that of a mail-client. This is because most “mail-clients” only connect with very few mail-servers, whereas mail-servers often connect to many more mail servers.

Given a connection graph G(E, V) of a network for a preset time period, the following process may be used to detect mail servers in a network.

| Process 1 IdentifyMailServer(Graph G) | |
|---|---|
| Require: A graph of network links for some time period | |
| t. | |
| Ensure: Mail servers in the graph during time period | |
| t. | |
| 1: medianFanout ← BinaryTree(Vertex, sort_by(Fanout)) | |
| 2: for (each Vertex v in G) do | |
| 3: | fanout ← computeFanout(v, |

a. RestrictTo(MailServerPorts( )))

| 4: medianFanout.insert(v, fanout) | |
|---|---|
| 5: end for | |
| 6: mailServers ← BinaryTree(Vertex) | |
| 7: Vertex medianVertex ← medianFanout.getRoot( ) | |
| 8: for (each Vertex v in G) do | |
| 9: | if (medianVertex.getFanout(MailServerPorts( )) ≦ |
| ii. v.getFanout(MailServerPorts( ))) then | |
| 10: | mailServers.insert(v) |
| 11: | end if |

12: end for

This process detects mail servers in general. Recall that simple port-based detection of a mail-server is not possible since SMTP is a symmetric protocol in that mail-clients and mail-servers use the same protocol to send and transfer mail. Therefore the foregoing process relies on the fan out of each node to determine whether it is a mail-server or not. In this particular case, the median of the fanout across all clients in the graph is used to distinguish mail-servers from mail-clients.

Besides fan out, one or more other appropriate metrics, such as conditional entropy of destination IPs of mail traffic, may be used instead, or in addition.

Having described how mail-servers may be detected, detection of spam bots can follow using one or more of the following strategies: (i) report every mail server found in the network as a spammer, and present to a network administrator to manually “clean up” the list by whitelisting innocent mail-servers from the list; (ii) query appropriate DNS servers to find out designated mail-servers for the domain, eliminate those servers automatically from the list, and report the rest of them as spammers; (iii) compute the fan out on a domain, AS, and/or country level, and report the servers with the highest fan outs on the top of the list as spammers; and (iv) compute (conditional) entropy of the fan out edges as given by domain, AS, and/or country with respect to the historic values, and identify mail-servers with entropy above a determined threshold as spammers (This is because legitimate mail servers tend to have lower entropy whereas spam bots will have higher entropy. This trend is present because legitimate mail servers tend to repeatedly connect to the same set of mail servers whereas spam servers may connect to arbitrary mail servers.).

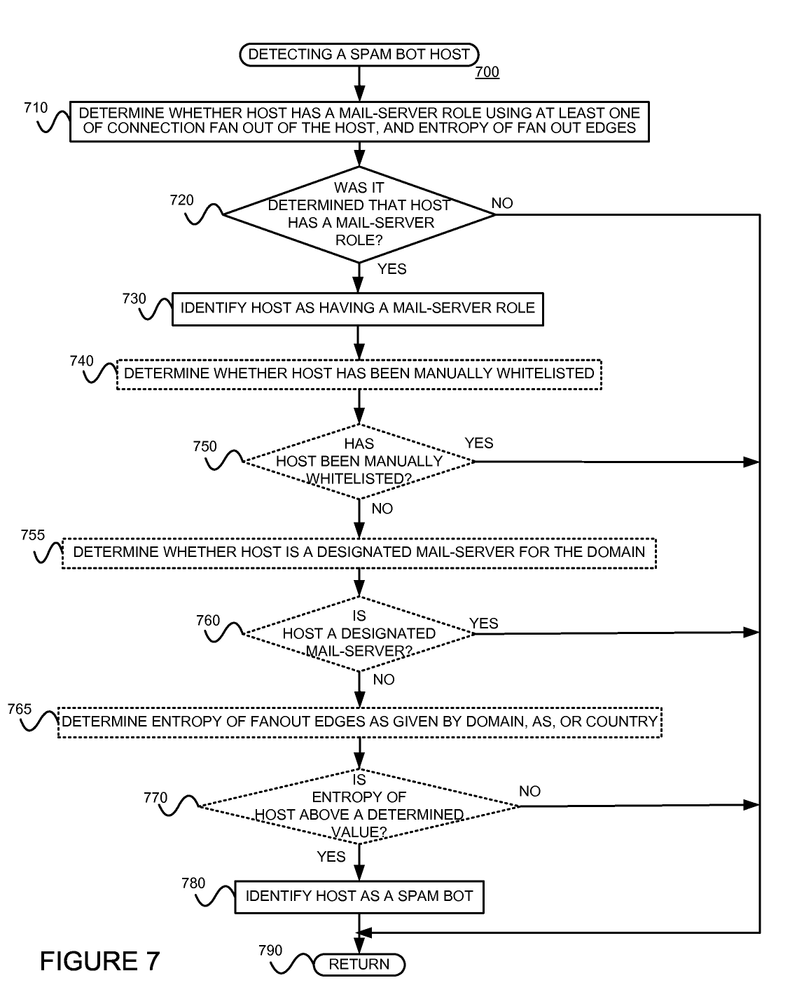

FIG. 7 is a flow diagram of an exemplary method 700 that may be used to detect hosts with a spam bot mail-server role, in a manner consistent with the present invention. It is determined whether a host has a mail-server role using at least one of (i) connection fan out of the host, and (ii) entropy of fan out edges. (Block 710) If it was determined that the host does not have a mail server role, the method is left. (Decision 720 and node 790) If, on the other hand, it was determined that the host has a mail server role (Decision 720), it is identified as a “mail server” (Block 730) and the method continues to determine whether or not the host is a “spam bot mail-server”. This further determination may use one or more of the following techniques. As a first technique, it is determined whether the host has been manually whitelisted. (Block 740) If so, the host is not identified as a spam bot mail-server and the method is left. (Decision 750 and node 790) As a second technique, it is determined whether the host is a designated mail-server for the domain. (Block 755) If so, the host is not identified as a spam bot mail-server and the method is left. (Decision 760 and node 790) As a third technique, the entropy of fan out edges as given by domain, AS, and/or country is determined. (Block 765) If the entropy of the host is above a determined (e.g., predetermined) value (Decision 770), the host is identified as a spam bot mail-server (Block 780) and the method 700 is left (Node 790). If not (Decision 770), the method 700 is left (Node 790).

§4.4.2.2 Detecting a Phishing Server

A compromised host might be used as a phishing server, where attackers host a fake web site of an organization to steal personal information from unsuspecting users. In order to do this the attacker converts a compromised host to a web-server. Therefore, detecting that the role of a host has just changed to a “web-server” can help detect phishing servers.

§4.4.2.3 Detecting a Brute Forcer

A compromised host may be used to “brute force” services, such as SSH, SQL servers, and FTP servers, on other hosts. This can be detected immediately when the role of a host changes to a “brute forcer.” Suppose network activities of a set of hosts are represented by a graph G(E, V), the following exemplary process may be used to detect brute forcers in an application/service agnostic manner, and in a manner consistent with the present invention. The process tracks the number of links established to and from a host for a particular service. Periodically, it computes the median on the number of links established for, or to, a particular service by all hosts in a network. Then, the process simply classifies (and labels) all hosts that have a number of links to a service above the median number of links to the service as candidate brute forcer of the service. Thereafter, the process uses the links on hosts that are not labeled as brute forcers (or candidate brute forcers) to obtain the median link time for the service. This information is used to filter out busy servers/clients and crawlers from the list of candidate brute forcers. Once the median link time is obtained, the process goes through the list of candidate brute forcers obtained and eliminates all candidate hosts that are on and above the median link time, and preserves the candidate hosts below median in the brute forcer list to generate a final list of brute forcers.

The final list of brute forcers can be prioritized using the entropy between link establishment time on a per service basis. More specifically, most of the time, brute forcers attempt to establish connections periodically. Therefore time between links tend to have lower entropy. Not only time between links but also properties such as number of packets per-link, number of bytes-per-link, duration of the link are all good candidates that take on very predictable (low entropy) values in the presence of brute forcing.

Process 2 IdentifyBruteForcers(Graph G)
Require:A graph of network activity for some time
period t.
Ensure: Hosts that are attempting to brute force a
service.

| i. | //Compute median fanout for each service port |
|---|---|
| 1: | medianVertex ← BinaryTree(Vertex, sort by(Fanout)) |
| 2: | for (each Vertex v in G) do |
| 3: | fanout ← computeFanout(v, GroupByPort( )) |
| 4: | medianVertex.insert(v, fanout) |
| 5: | end for |

//Identify any host above median as brute forcer

| | |
|---|---|
| 6: | bruteForcers ← BinaryTree(Vertex) |
| 7: | Vertex median ← medianVertex.getRoot( ) |
| 8: | for (each Vertex v in G) do |
| 9: | if (medianVertex.getFanout(GroupByPorts( )) ≦ |
| ii. | v.getFanout(GroupByPorts( ))) then |
| 10: | bruteForcers.insert(v) |
| 11: | end if |
| 12: | end for |
| iii. | //Compute median link time for each service |
| 13: | medianLinkTime ← 0 |
| 14: | for (each Vertex v in G) do |
| 15: | if (medianVertex.getFanout(GroupByPorts( )) ≧ |
| iv. | v.getFanout(GroupByPorts( ))) then |
| 16: | medianLinkTime |

median(v.getLinkTime(GroupByPorts( )))

| | |
|---|---|
| 17: | end if |
| 18: | end for |
| v. | //Remove brute forcers above median link time for |
| | each service |
| 19: | medianLinkTime ← 0 |
| 20: | for (each Vertex v in G) do |
| 21: | if (medianLinkTime.(GroupByPorts( )) ≦ |
| vi. | v.getLinkTime(GroupByPorts( ))) then |
| 22: | bruteForcers.remove(v) |
| 23: | end if |
| 24: | end for |

§4.4.2.4 Detecting a Crawler

In general a crawler consumes a particular type of resource from around the network. For example, a web crawler consumes web pages by following many hyper-links across the World Wide Web. Similarly, a host recruited to commit Click-Fraud basically crawls the web by clicking on advertisements. When a role detection component consistent with the present invention identifies a host as a “crawler,” it can determine what type of crawler it is by examining the URL requests as well as the sources of content. If a host is determined to have the role, “crawler,” it may be tagged with the appropriate information and sent to a diagnosis component.

Similar to brute forcers, crawlers also tend to have above average fan outs. Therefore, the first phase of brute force detection (to find candidate brute forcers) can also be used to detect potential crawlers. Unlike brute forcers, however, crawlers generally exhibit on or above median link times. This is one distinction between crawlers and brute forcers. Therefore, hosts that are discarded as brute forcer candidates can be used to detect crawlers.

As described in the examples below, further specializations can be done to narrow down the scope of crawlers.

Content-based crawlers specifically look for a particular type of content. For example, simple search engine crawlers only look for plain text (HTML), whereas specialized image search engine crawlers look for only image types. By looking at the flow records created by the content tracking component (Recall 120 of FIG. 1.), such content specific crawlers can be distinguished from one another. Moreover, web crawlers are easier to identify (at least the ones that follow web crawling etiquette) by simply looking for their HTTP request for robots.txt, their frequent use of HEAD HTTP command, and perhaps a obscure name for its User-Agent:.

Click fraud bots are another specialized crawler. In a click fraud scheme, a host or set of hosts are programmed to click on online advertisements to either make money from a perpetrators account, or to drive the cost of advertising to a competitor. In either case, this host will be detected as a crawler as it tends to connect to a lot of web hosts that serve advertisements or to IP addresses, domains, and/or ASs that serve advertisements.

§4.4.2.5 Detecting P2P Nodes

Another useful role to identify is whether there are hosts in a network that are part of a peer-to-peer (“P2P”) network. This role is referred to as a host being a P2P node. Currently, most of the links that hosts make are generally preceded by a name resolution such as DNS. However, most peer-to-peer networks do not use name resolution in a network because their peers are advertised through their own overlay protocol. Therefore, embodiments consistent with the present invention may track the number of connections made without a name resolution, and further track links to other hosts with the same symptom. If the number of connections made without a name resolution is greater than a determined value (or if a ratio of connections made without a name resolution to connections made with a name resolution is more than a determined value), and/or if there are more than a determined number of links to other hosts with the same symptom, the host may be indicated as having a peer-to-peer role.

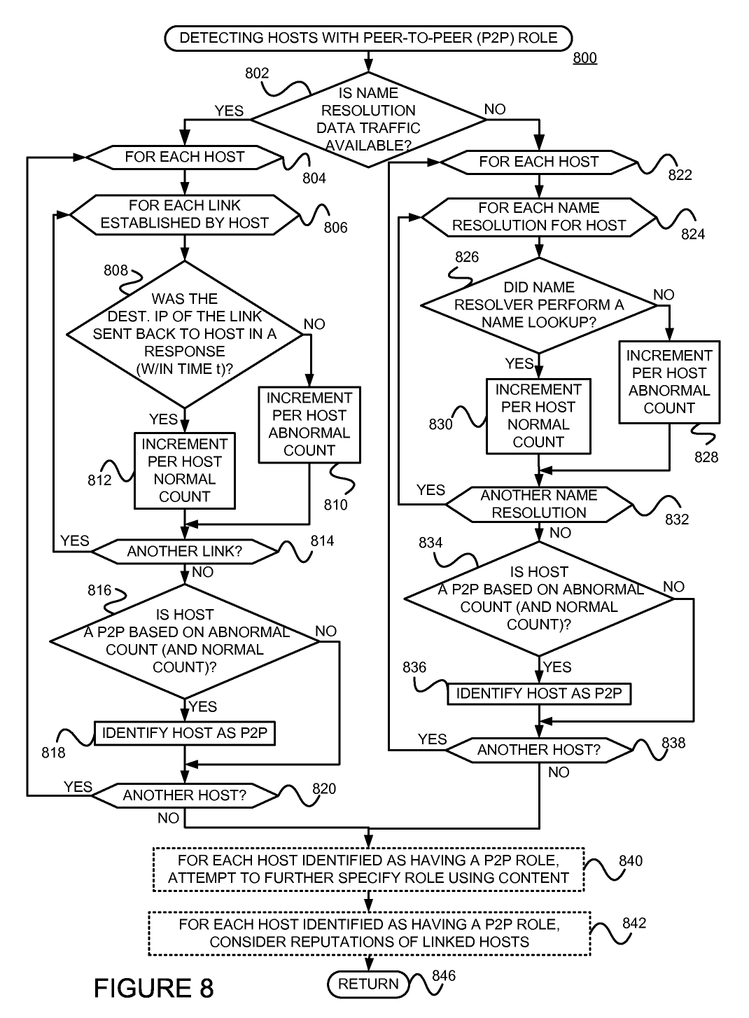

FIG. 8 is a flow diagram of an exemplary method 800 that may be used to detect hosts with a P2P role, in a manner consistent with the present invention. The left or right branch of the method is performed depending on whether name resolution data traffic is available. If so, the left branch of the method 800 is performed. (See 802 and 804.) If not, the right branch of the method 800 is performed. (See 802 and 822.)

Referring to the left branch, for each host being considered, a number of acts are performed. (Loop 804-820) For a given host, for each link established by the host (Loop 806-814), it is determined whether the destination IP address of the link was sent back to the host in a response (e.g., within a determined time). (Block 808) That is, it is determined whether or not a DNS name was resolved. If not, an abnormal count for the host is incremented (Block 810), but if so, a normal count for the host may be incremented (if such a count is used). (Block 812) Once all of the links for the host have been processed, whether or not the host is to be identified as a P2P role host can be determined using the abnormal count (and perhaps the normal count). (Decision 816 and block 818) Otherwise, the host is not identified as a P2P role host. (Decision 816)

Referring to the right branch, for each host being considered, a number of acts are performed. (Loop 822-838) For a given host, for each name resolution for the host (Loop 824-832), it is determined whether or not the name resolver performed a name lookup. (Block 826) That is, it is determined whether or not a DNS name was resolved. If not, an abnormal count for the host is incremented (Block 828), but if so, a normal count for the host may be incremented (if such a count is used) (Block 830) Once all of the links for the host have been processed, whether or not the host is to be identified as a P2P role host can be determined using the abnormal count (and perhaps the normal count). (Decision 834 and block 836) Otherwise, the host is not identified as a P2P role host. (Decision 834)

Referring back to decisions 816 and 834, whether or not a host is identified as a P2P role host may be determined various ways using at least the host abnormal count. For example, under one technique consistent with the present invention, the host is identified as a P2P role host if the abnormal count (e.g., for given time period) is greater than a determined (e.g., predetermined) value. As another example, the host is identified as a P2P role host if a ratio of the abnormal count to normal count (e.g., for given time period) is greater than a determined (e.g., predetermined) value.

Finally, for each host identified as having a P2P role, the role of the host may be further specified. (Block 840) Alternatively, or in addition, for each host identified as having a P2P role, the reputation of hosts linked to the P2P host may be considered. (Block 842)

As can be appreciated from the foregoing, there are two methods to identify hosts that establish a link without name resolution. The method chosen depends on whether sensor modules (Recall 115 of FIG. 1.) can or cannot observe the traffic between name resolution servers and hosts. (In short, whether sensors can see internal network traffic, or have access to DNS logs, or can only see traffic between networks and not the traffic between DNS and hosts.) Determining whether a link was made with or without a name resolution can be based on whether a host received appropriate name resolution from a resolver for a destination IP.

When appropriate name resolution data/traffic is available, for each link established by a host, the name resolution responses may be analyzed to determine whether the destination IP of the link has been part of a response sent to the host within a particular time period. When such a response is not found a counter is incremented. On the other hand, when appropriate name resolution data/traffic is not available, then a lookup by the resolver itself is considered a successful lookup by the host. That is, as long as a resolver in the network has appropriate resolution for the destination IP, then it is assumed the look up was made on behalf of the host looking to establish the link. This scenario is useful in most deployments when traffic between the name server and hosts is not available and/or name servers logs are not available.

Once the symptom establishes that the host has the role of P2P peer, the purpose of the peers in the network may be diagnosed. For example, referring to block 840 of FIG. 8, the type of content traversing the links that did not have name look ups can be analyzed. Based on the content type, whether similar hosts are part of a peer-to-peer node, and the type of service they provide can be determined. For example, hosts connecting to other hosts through links that contain multimedia traffic may be determined to be peer-to-peer networks for file sharing. As another example, referring to block 842 of FIG. 8, suspected peer-to-peer hosts and their link properties (such as port numbers used for connection, other peers (common peers with respect to IP address/bitwise neighbors, AS, domain, or country)) may be analyzed to identify whether the hosts are linked or part of a network. These examples illustrate that when a host has a P2P role, it can be further determined whether a host is in fact part of a peer-to-peer network and the type of network (such as a file sharing network, a bot network, etc.) of which it is part.

§4.4.3 Examples of Using Reputation for Detection

§4.4.3.1 Detecting a Bot Using Fast-Flux

A fast-flux bot uses DNS to change the command and control servers of an infected host frequently. The current technique for changing fast-flux domain-to-IP mappings is to have a shorter time to live value (“TTL”) for the domain name. Detection based solely on a shorter TTL can result in false positives (since a proper value for TTL cannot be quantified for a domain name). TTL of DNS records can be seconds, minutes, or hours. Furthermore, if and when attackers move from using a shorter TTL to using round-robin DNS based fast-flux, the TTL-based detection method would not work at all. This is because many legitimate services, such as Google, YouTube, Yahoo!, etc., use round-robin DNS names for load balancing.

To distinguish between a legitimate round-robin DNS and a potential fast-flux, some exemplary embodiments consistent with the present invention use the reputation of IP addresses associated with the domain name. For example, domain name “example.com” can be assigned the reputation of IP addresses it is associated with as shown below:

$${R}_{example . com} = {( {\prod }_{i = 0}^{n} {R}_{i} )}^{\frac{1}{n}} \qquad ( 4 )$$

When a low reputation domain name is being used for round-robin DNS names (a role), the system can flag it as a potential fast-flux domain name. Furthermore, any host that is in contact with such a domain name has a good chance of being a bot.

Moreover, in addition to using reputation as a metric for refining a list of candidate fast-flux domain names, the list of candidate fast-flux domain names can further be refined by considering the diversity of IP addresses associated with a domain. In general, diversity of IP addresses may be a function of one or more of (i) the number of unique AS/countries that the IP addresses of a domain belong to, and (ii) the number of other domains that have been represented by the IP addresses in the recent past. The more diverse the IP addresses of a domain, the more likely the domain is a fast-flux domain.

Any host resolving a fast-flux domain, and/or making contact with the IP addresses represented by these domains are highly likely to be a bot.

§4.4.3.2 Detecting a Compromised Perimeter Protection

Most enterprises use a variety of perimeter defenses, such as proxies, firewalls, intrusion detection systems, etc., to protect their networks. Using the reputation of IP addresses coming out of this perimeter is a good indication on how well the perimeter is protected. For example, most organizations use web proxies to tunnel web requests to the Internet. The web proxy is often used to enforce use policies, as well as to filter out malicious content from entering the network. However, most of the techniques employed by such devices use signature matching and/or black listing to identify malicious sites or content. With the help of a reputation system, reputation of a host in a network (R_{H}) can be computed as a function of the reputation of hosts (domains, AS, countries) it connects with (R_{I}) as shown below:

$${R}_{H} = {( {\prod }_{i = 0}^{n} {R}_{i} )}^{\frac{1}{n}} \qquad ( 5 )$$

Therefore, whenever the reputation of the proxy or the reputation of hosts in a network in general go down, the system can infer that the network perimeter protections have been subverted.

§4.4.3.3 Detecting a DNS Poisoning or Pharming

DNS poisoning is an attack on the domain name system to associate an illegitimate IP address with a legitimate domain name. For example, using DNS poisoning, an attacker can associate the domain names of well known banks to that of a fake bank to harvest personal information from people who believe they are interacting with a legitimate bank web site.

DNS poisoning can happen in various places. For example, it can happen at a vulnerable DNS server for an organization where it would affect the entire organization, or it can happen at a home router where it could affect the entire household, or it could affect a single host (e.g. modified “/etc/hosts,” which is a file where users can place static DNS resolutions) where it affects the users of the host(s). All cases of DNS poisoning can be detected by monitoring appropriate reference parameters. For example, to detect the first two cases, an exemplary system consistent with the present invention might monitor the reputation of domain names as described in equation (4). If the reputation of the domain decreases too much and/or too fast, DNS poisoning may be inferred. To detect the third case where the DNS resolution happens within a host itself, the reputation of hosts indicated in Host: field of HTTP protocol may be monitored.

Pharming is a type of attack that relies on DNS poisoning. Therefore, when a DNS poisoning attempt is detected, the resolving IP may be identified as potential “pharmer.”

§4.4.3.4 Detecting a Typo-Squatter

So-called “typo-squatting” or “URL hijacking” relies on typographical or perceptual mistakes made by Internet users. For example, criminals may setup a web site that looks like that of Citi Bank citi.com at c1ti.com (or at citi.cm, or something similar), and refer to this URL in spam emails. This type of attack relies on perceptual mistakes made by users to mistakenly follow a typo link to an illegitimate web site where personal information may be stolen.

In order to detect typo-squatting domain names, exemplary embodiments consistent with the present invention may consider inherent properties of typo-squatting domains in general. Examples of such inherent properties such as relatively low edit distance from legitimate websites, and relatively low reputation. Each of these properties is described below.

Since the whole purpose of typo-squatting domains is to look as similar as possible to an original domain, to accomplish this, typo-squatters register domains that look very similar to the original domain. This similarity can be quantified using one of many edit distance functions, such as Levenshtein distance, Hamming distance, or Wagner-Fischer edit distance. A set of domains with relatively low edit distances might indicate the presence of a typo-squatter (or it might indicate that the original domain holder has preemptively registered potential typo-squatting domains). So there is a legitimate possibility and an illegitimate possibility.

Reputation may be used to distinguish between these two possibilities. Typically, a typo-squatter domain tends to have a lower reputation than the original domain. This happens because these domains are generally hosted on compromised hosts, or on ASs/network segments where other hosts also have bad reputations. Therefore, a typo-squatter domain can be defined as a domain that has the least edit distance to an already known domain, and the largest different in reputation (or more than a determined difference) from the original site. (In most cases, a typo-squatter domain will have a lower reputation.) The following process shows how to identify typo-squatters in real-time by monitoring traffic a network.

| | |
|---|---|
| Process 3 | IsTypoSquatter(DomainName D) |
| Require: | A domain name D and a suffix tree editTree from |

| | |
|---|---|
| i. | previous instance of this function. |

| | |
|---|---|
| Ensure: | Returns true if the domain is a typo-squatter. |

| | |
|---|---|
| ii. | False otherwise. |

| 1: editDistance ← editTree.getEditDistance(D); | |
|---|---|
| 2: if (editDistance ≦ α) then | |
| 3: | domainReputation ← GetReputation(D); |
| 4: | if (domainReputation ≦ γ) then |

| | |
|---|---|
| 5: | return true |

| | |
|---|---|
| 6: | end if |

7: end if
editTree.insert(D)
8: return false

The minimum edit distance α and minimum variation γ in reputation can be adjusted by end users, or can be adopted according to feedback from false positives and false negatives.

§4.4.3.5 Identifying an Infected Web Site

One of the major problems facing the protection of hosts is the evolution of completely web-based attack vectors. Attackers have used Java script to essentially “infect” websites so that such websites will, in turn, infect unsuspecting users as they browse these websites. These attacks are known as “drive-by-downloading” attacks. It is important to identify these websites to prevent the spread of web-based infections. Web-based infections generally redirect a user's browser to download and install malware by referencing or loading a link in the background while the user is on the website. More often than not, these downloads come from a third party website designed to serve malware.

A subset of web-based infections can be determined using reputation. For example, when a web page is loaded, a host establishes multiple connections to appropriate web servers—one for downloading the main page, followed by a burst of connections to download corresponding images, style sheets, Java script files, as well as other resources referenced in the page. Usually all these resources come from the same web server, or from web servers with similar reputation. However, if a website is infected with a drive-by-downloading malware, where the malware is hosted in a third party network, accessing such a website would not only result in a request for the malware from a separate web server, but also from a web server with a potentially bad reputation. Therefore, such drive-by-downloading malware can be detected by (i) tracking web requests for each host, (ii) tracking the corresponding servers' reputations, and (iii) identifying an infected website by analyzing a variance in the reputations of web servers contacted per request. A wide variance in the reputations of the web servers might indicate the presence of drive-by-downloading malware. That is, the sequence of web server requests as a whole may be analyzed. In such a sequence, the initial request is the request for the web page itself, followed by requests for resources necessary to render the web page. If any subsequent request has a lower reputation than the leading request (or a reputation more than a determined amount lower than the leading request), the website might be identified as being infected. This is because one or more elements in the main web page is served by a lower reputation host (which is unlikely to happen unless the page is infected).

Another method to determine whether a web page is infected or not is to analyze the variance of reputation in the request sequence. A higher variance generally indicates that the web page is more likely to be infected.

§4.4.3.6 Using Reputation to Augment Results

As described earlier reputation of hosts can also be used in conjunction with symptoms and roles. This can be used to prioritize analysis, or to display most relevant evidence up front to reduce tedious review by end users.

§4.5 Exemplary Apparatus

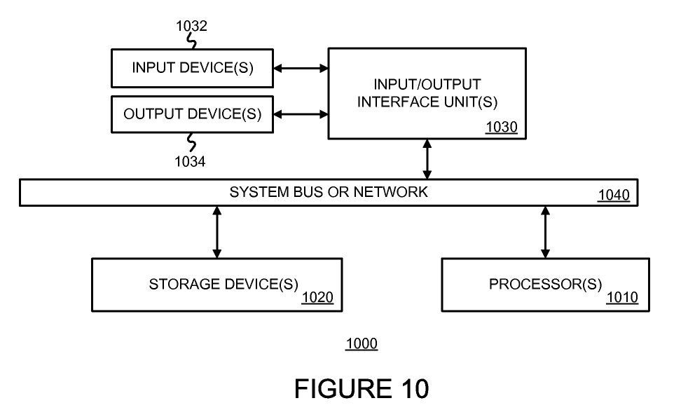

FIG. 10 is a block diagram of exemplary apparatus 1000 that may be used to perform operations of various components in a manner consistent with the present invention and/or to store information in a manner consistent with the present invention. The apparatus 1000 includes one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. For example, one or more software modules (or components), when executed by a processor, may be used to perform one or more of the methods of FIGS. 3-8. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers or servers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 930 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

The operations of components, such as those described above, may be performed on one or more computers. Such computers may communicate with each other via one or more networks, such as the Internet for example. The hosts can be nodes such as desktop computers, laptop computers, personal digital assistants, mobile telephones, other mobile devices, servers, etc. They can even be nodes that might not have a video display screen, such as routers, modems, set top boxes, etc.

Alternatively, or in addition, the various operations and acts described above may be implemented in hardware (e.g., integrated circuits, application specific integrated circuits (ASICs), field programmable gate or logic arrays (FPGAs), etc.).

What is claimed is:

1. A computer-implemented method for determining an infection risk of a host computer on a network, the computer-implemented method comprising:
a) determining at least two of
(1) host-centric symptom information for the host computer,
(2) host-centric role information for the host computer, and
(3) host-centric reputation information for the host computer,
from the stored network data; and
b) determining the infection risk of the host computer using at least two of (1) the determined host-centric symptom information, (2) the determined host-centric role information, and (3) the determined host-centric reputation information.

2. The computer-implemented method of claim 1 wherein the determined host-centric symptom information is signature-free information.

3. The computer-implemented method of claim 1 wherein the determined host-centric symptom information does not include baseline information of the host.

4. The computer-implemented method of claim 1 wherein determining the infection risk of the host computer uses the determined host-centric role information, and
wherein the determined host-centric role information includes one of (A) a consumer with respect to at least one other system on the network, (B) a producer with respect to at least one other system on the network, and (C) a relay with respect to at least two other systems on the network.

5. The computer-implemented method of claim 1 wherein determining the infection risk of the host computer uses the determined host-centric reputation information, and
wherein the determined host-centric reputation information is determined using a reputation of at least one other system on the network with which the host has sent or received information.

6. The computer-implemented method of claim 5 wherein the determined host-centric reputation information is determined further using a characterization of traffic the host has received or sent.

7. The computer-implemented method of claim 1 wherein determining the infection risk of the host computer uses the determined host-centric symptom information, and
wherein the determined host-centric symptom information includes at least one of (A) protocol semantic violations by the host, (B) access to dark space by the host, (C) slowdown of the host, (D) change of role of the host, (E) unusual reboot statistics of the host, (F) contact with typo squatter domains by the host, (G) command channels used by the host, (H) control channel used by the host, and (I) rate of advertisement selections by the host exceeding a threshold.

8. The computer-implemented method of claim 1 wherein determining the infection risk of the host computer uses the determined host-centric role information, and
wherein the determined host-centric role information is a service level role determined using tuples of network information forwarded by the host.

9. The computer-implemented method of claim 1 further comprising refining the role of the host using information from special purpose network appliances that monitor traffic on the network for applications in at least one of security, billing and traffic engineering,
wherein determining the infection risk of the host computer uses the determined host-centric role information.

10. A computer-implemented method for assigning a reputation to a host, the computer-implemented method comprising:
a) receiving assigned reputation information of a set of other hosts;
b) determining, from the set of other hosts, hosts associated with the host using at least one of (i) communications between the host and each of the other hosts, (ii) a bit-wise difference in IP addresses of the host and of each of the other hosts, (iii) domains of the host and of each of the other hosts, (iv) autonomous systems of the host and of each of the other hosts, and (v) countries of the host and each of the other hosts; and
c) inferring a reputation value of the host using assigned reputation information of hosts from the set of other hosts, that were determined to be related to the host.

11. A computer-implemented method for determining whether a host is a spam bot mail-server, the computer-implemented method comprising:
a) determining whether or not a host has a mail-server role using at least one of (i) connection fan out of the host, and (ii) entropy of the fan out edges of the host;
b) responsive to a determination that the host is a mail-server, further determining whether the host is a spam bot mail-server using at least one of (i) a determination of whether or not the host has been whitelisted, (ii) a determination of whether or not the host is a designated mail-server for a domain to which the host belongs, and (iii) an entropy of the host; and
c) responsive to a determination that the host is a spam bot mail-server, identifying the host as a spam bot mail-server.

12. A computer-implemented method for determining whether a host is a peer-to-peer node, the computer-implemented method comprising:
a) tracking abnormal dynamic name to IP address resolutions by the host;
b) determining whether or not the host is a peer-to-peer node using a number of abnormal dynamic name to IP address resolutions; and
c) responsive to a determination that the host is a peer-to-peer node, identifying the host as a peer-to-peer node.

13. The computer-implemented method of claim 12 further comprising:
d) determining a more specific role of the host using content communicated by the host.

14. The computer-implemented method of claim 12 further comprising:
d) determining a more specific role of the host using reputation information of other hosts that have been connected with the host.
